(19) United States
(12) Patent Application Publication
(10) Pub. No.: US 2023/0294282 A1
(43) Pub. Date: Sep. 21, 2023

(54) INFORMATION PROCESSING DEVICE, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Yutaro ISHIDA, Toyota-shi (JP); Taro TAKAHASHI, Urayasu-shi (JP)

(73) Assignee: TOYOTA JIDOSHA KABUSHIKI KAISHA, Toyota-shi (JP)

(21) Appl. No.: 18/096,195

(22) Filed: Jan. 12, 2023

(30) Foreign Application Priority Data
Mar. 16, 2022 (JP) 2022-041332

(51) Int. Cl. B25J 9/16

(52) U.S. Cl. CPC B25J 9/1661; B25J 9/1664; B25J 9/1697

(57) ABSTRACT

The information processing device includes an acquisition unit, a recognition unit, and a specification unit. The acquisition unit is configured to acquire information indicating an action trajectory of an expert for a specific task. The recognition unit is configured to recognize each operation on the target object in time series based on the action trajectory. The specification unit is configured to specify each operation for causing the robot to execute the task based on each operation recognized by the recognition unit and a configuration of the robot.

### CROSS-REFERENCE TO RELATED APPLICATION

This application claims priority to Japanese Patent Application No. 2022-041332 filed on Mar. 16, 2022, incorporated herein by reference in its entirety.

### BACKGROUND

### 1. Technical Field

The present disclosure relates to an information processing device, an information processing method, and a non-transitory storage medium.

### 2. Description of Related Art

Conventionally, a technique has been known in which a robot is caused to execute a predetermined task by causing the robot to execute an operation in accordance with a state transition (state machine) designed and implemented by a human being who is the developer (for example, see Japanese Unexamined Patent Application Publication No. 2019-200792 (JP 2019-200792 A)).

### SUMMARY

However, in the prior art, for example, it may be difficult to enable a robot to execute a new task (a task that is not supported when the robot is developed).

An object of the present disclosure is to provide an information processing device, an information processing method, and a non-transitory storage medium that cause a robot to appropriately execute a new task.

An information processing device according to a first aspect of the present disclosure includes: an acquisition unit configured to acquire information indicating an action trajectory of an expert for a specific task; a recognition unit configured to recognize each operation for a target object in time series based on the action trajectory; and a specification unit configured to specify each operation of causing a robot to execute the task based on the each operation recognized by the recognition unit and a configuration of the robot.

In the information processing device according to the first aspect, the action trajectory may include an operation of, while fixing one part of the target object by one arm, applying a force to the other part of the target object by the other arm. The specification unit may be configured to specify an operation of causing one arm of the robot to execute an operation of applying a force to the other part after fixing the target object using a specific tool.

In the information processing device according to the first aspect, the target object may include a plurality of objects. The action trajectory may include an operation of, while fixing one object by one arm, taking out the other object by the other arm. The specification unit may be configured to specify an operation of causing one arm of the robot to execute an operation of taking out the other object after fixing the one object with a specific tool.

In the information processing device according to the first aspect, the target object may include a plurality of objects. The action trajectory may include an operation of, while holding one object by one arm, applying a force to the other object by the other arm. The specification unit may be configured to specify an operation of causing one arm of the robot to execute an operation of applying a force to the other object after placing the one object.

In the information processing device according to the first aspect, the target object may include a plurality of objects. The action trajectory may include an operation of, while holding one object by one arm, applying a force to the other object by the other arm. The specification unit may be configured to specify an operation of causing one arm of the robot to execute an operation of applying a force to the other object while holding the one object.

An information processing method according to a second aspect of the present disclosure includes: acquiring information indicating an action trajectory of an expert for a specific task; recognizing each operation for a target object in time series based on the action trajectory; and specifying each operation of causing a robot to execute the task based on the recognized each operation and a configuration of the robot.

A non-transitory storage medium according to a third aspect of the present disclosure stores instructions that are executable by one or more processors and that cause the one or more processors to execute functions including: acquiring information indicating an action trajectory of an expert for a specific task; recognizing each operation for a target object in time series based on the action trajectory; and specifying each operation of causing a robot to execute the task based on the recognized each operation and a configuration of the robot.

According to such a configuration, the robot can be caused to appropriately execute a new task.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a configuration of an information processing system according to an embodiment;

FIG. 2 is a diagram illustrating an example of a hardware configuration of the information processing device according to the embodiment;

FIG. 3 is a diagram illustrating an example of a configuration of an information processing device according to the embodiment;

FIG. 4 is a flowchart illustrating an example of processing of the information processing device according to the embodiment; and

FIG. 5 is a diagram illustrating an example of an action trajectory of an expert and an operation performed by a robot according to the embodiment.

### DETAILED DESCRIPTION OF EMBODIMENTS

The principles of the present disclosure are described with reference to several exemplary embodiments. These embodiments are described by way of example only, and are intended to aid those skilled in the art in understanding and practicing the disclosure without suggesting limitations on the scope of the disclosure. The disclosure described herein may be implemented in a variety of ways other than those described below.

In the following description and claims, unless otherwise defined, all technical and scientific terms used herein have the same meaning as commonly understood by one of ordinary skill in the art to which this disclosure belongs.
Hereinafter, embodiments of the present disclosure will be described with reference to the drawings.

### System Configuration

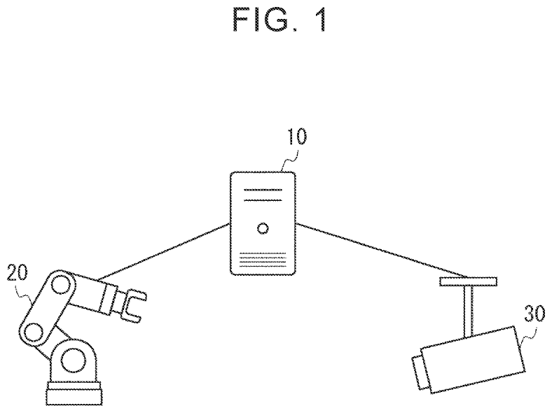

A configuration of the information processing system 1 according to the embodiment will be described with reference to FIG. 1. FIG. 1 is a diagram illustrating an example of a configuration of an information processing system 1 according to an embodiment. In the example of FIG. 1, the information processing system 1 includes an information processing device 10, a robot (an example of an “external device”) 20, and a sensor 30.

The information processing device 10 is a device that controls the robots using Artificial Intelligence (AI). For example, the information processing device 10 acquires, by the sensor 30, an operation when a human or the like executes a task (work) as information indicating an action trajectory of an expert. Then, the information processing device 10 determines each operation according to the physical property of the robot 20 based on the acquired information. Then, the information processing device 10 causes the robot 20 to execute the task by causing the robot 20 to perform the determined operations.

The robot 20 is a robot that performs a task by an arm or the like. The robot may be any device capable of executing various tasks, and the shape of the appearance is not limited. The robot 20 can be used, for example, for various purposes such as home use, search use, and factory use. The sensor 30 is a sensor that measures the periphery of the robot 20. The sensor 30 may be, for example, a camera or a LiDAR. Note that the number of the information processing device 10, the robot 20, and the sensor 30 is not limited to the example of FIG. 1. Note that the information processing device 10 and the sensor 30 may be accommodated in the housing of the robot 20.

### Hardware Configuration

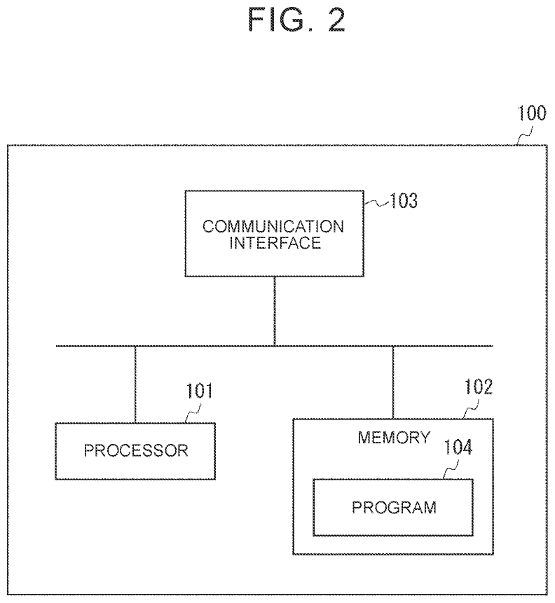

FIG. 2 is a diagram illustrating an example of a hardware configuration of the information processing device 10 according to the embodiment. In the example of FIG. 2, the information processing device 10 (computer 100) includes a processor 101, a memory 102, and a communication interface 103. These units may be connected by a bus or the like. The memory 102 stores at least a part of the program 104. The communication interface 103 includes an interface necessary for communication with other network elements.

When the program 104 is executed by the cooperation of the processor 101 and the memory 102, the computer 100 performs processing of at least a part of the embodiments of the present disclosure. The memory 102 may be of any type suitable for a local technology network. Memory 102 may be, by way of non-limiting example, a non-transitory computer-readable storage medium. Memory 102 may also be implemented using any suitable data storage technology, such as semiconductor-based memory devices, magnetic memory devices and systems, optical memory devices and systems, fixed and removable memory, and the like. Although only one memory 102 is shown in computer 100, there may be several physically different memory modules in computer 100. The processor 101 may be of any type. The processor 101 may include one or more of a general purpose computer, a special purpose computer, a microprocessor, a Digital Signal Processor (DSP, and as non-limiting examples, a processor based on a multi-core processor architecture. The computer 100 may comprise a plurality of processors, such as application specific integrated circuit chips, which are temporally dependent on the clock that synchronizes the main processor.

Embodiments of the present disclosure may be implemented in hardware or dedicated circuitry, software, logic, or any combination thereof. Some aspects may be implemented in hardware, while other aspects may be implemented in firmware or software that may be executed by a controller, microprocessor, or other computing device.

The present disclosure also provides at least one computer program product tangibly stored on a non-transitory computer readable storage medium. The computer program product includes computer-executable instructions, such as instructions contained in a program module, executed on a device on a real or virtual processor of interest to perform the processes or methods of the present disclosure. Program modules include routines, programs, libraries, objects, classes, components, data structures, etc. that perform particular tasks or implement particular abstract data types. The functionality of the program modules may be combined or split between the program modules as desired in various embodiments. The machine-executable instructions of the program modules may be executed in a local or distributed device. In a distributed device, program modules can be located on both local and remote storage media.

Program code for performing the methods of the present disclosure may be written in any combination of one or more programming languages. These program codes are provided to a processor or controller of a general purpose computer, special purpose computer, or other programmable data processing device. When program code is executed by a processor or controller, functions/operations in the flowcharts and/or implementing block diagrams are performed. The program code is executed entirely on the machine, partly on the machine, as a stand-alone software package, partly on the machine, partly on the remote machine, or entirely on the remote machine or server.

The program can be stored using various types of non-transitory computer readable media and supplied to a computer. Non-transitory computer-readable media include various types of tangible recording media. Examples of non-transitory computer-readable media include magnetic recording media, magneto-optical recording media, optical disk media, semiconductor memory, and the like. Examples of the magnetic recording medium include a flexible disk, a magnetic tape, and a hard disk drive. The magneto-optical recording medium includes, for example, a magneto-optical disk. Optical disc media include, for example, Blu-ray discs, Compact Disc Read Only Memory (CD-ROM), Compact Disc Recordable (CD-R), Compact Disc Re Writable (CD-RW), etc. Semiconductor memories include, for example, solid-state drives, mask ROM, Programmable Read Only Memory (PROM), Erasable Programmable Read Only Memory (EPROM), flash ROM, random access memory (RAM), etc. The program may also be supplied to the computer by various types of transitory computer readable media. Examples of the transitory computer-readable media include electrical signals, optical signals, and electromagnetic waves. The transitory computer-readable media can supply the program to the computer via a wired communication path such as an electric wire and an optical fiber, or a wireless communication path.

### Configuration

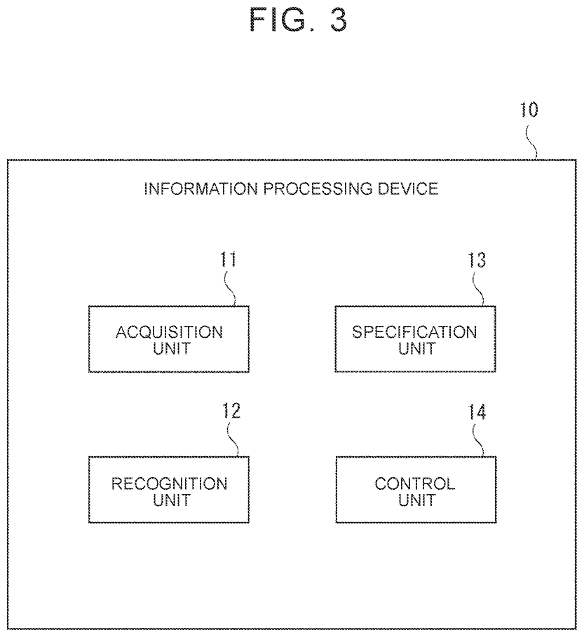

Next, a configuration of the information processing device 10 according to the embodiment will be described with reference to FIG. 3. FIG. 3 is a diagram illustrating an example of a configuration of the information processing device 10 according to the embodiment. In the example of FIG. 3, the information processing device 10 includes an acquisition unit 11, a recognition unit 12, a specification unit 13, and a control unit 14. These units may be realized by cooperation of one or more programs installed in the information processing device 10 and hardware such as the processor 101 and the memory 102 of the information processing device 10.

The acquisition unit 11 acquires information indicating an action trajectory of an expert for a specific task. The recognition unit 12 recognizes each operation on the target object in time series based on the action trajectory acquired by the acquisition unit 11.

The specification unit 13 specifies (determines) each operation for causing the robot 20 to execute the specific task based on each operation recognized by the recognition unit 12 and the configuration of the robot 20. The control unit 14 controls the robot 20 based on the information indicating each operation specified by the specification unit 13.

### Processing

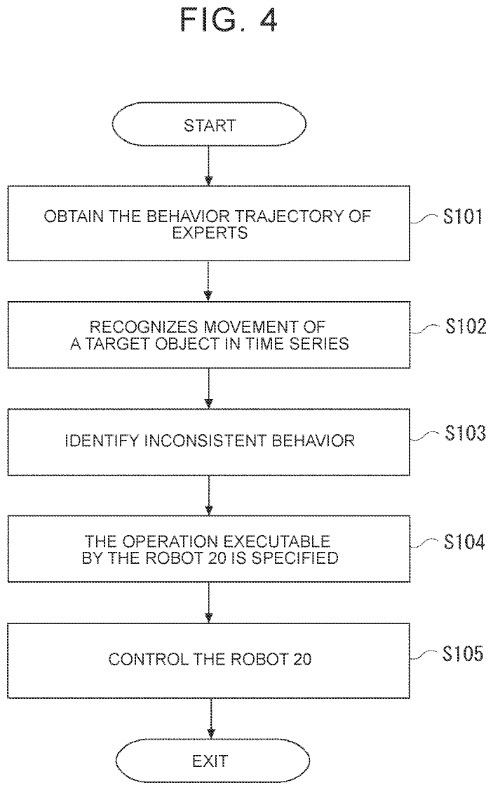

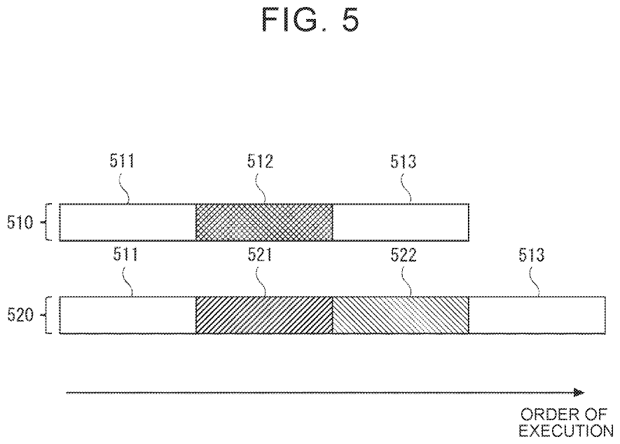

Next, an example of processing of the information processing device 10 according to the embodiment will be described with reference to FIG. 4 and FIG. 5. FIG. 4 is a flowchart illustrating an example of processing performed by the information processing device 10 according to the embodiment. FIG. 5 is a diagram illustrating an example of an action trajectory of an expert and an operation performed by the robot 20 according to the embodiment.

In S101 of steps, the acquisition unit 11 of the information processing device 10 acquires information indicating an action trajectory of an expert with respect to a particular task. A particular task may be, for example, removing items from a bottle, or removing items from a refrigerator, etc. Here, the information indicating the action trajectory of the expert may include, for example, information indicating the position, the moving speed, the change in the shape, and the like of each part of the object operated by the specific task. Further, the information indicating the action trajectory of the expert may include, for example, information indicating the position, posture, and the like of the human arm at each time point when a specific task is executed by the human.

The information indicating the action trajectory of the expert may be generated, for example, by analyzing images captured by the sensor 30, which is a camera, with a Convolutional Neural Network (CNN). The information indicating the action trajectory of the expert may include, for example, information indicating the position, the moving speed, the change in the shape, and the like of each part of the object (target object) operated by the specific task.

Subsequently, the recognition unit 12 of the information processing device recognizes the motion of the target object in time series on the basis of the information indicating the action trajectory of the expert (step S102). Here, for example, the recognition unit 12 may extract (decompose) the motion (processing, operation) with respect to the target object in the specific task in time series from the action trajectory of the expert.

Subsequently, the specification unit 13 of the information processing device 10 specifies an operation (inconsistent operation) that is inconsistent with the configuration (physical property) of the robot 20 among the operations in the time series recognized by the recognition unit 12 (step S103). Here, the specification unit 13 may specify a plurality of operations (methods) that can be executed by the robot 20 and that can realize an action by each operation with respect to each of the operations in the time series recognized by the recognition unit 12. Then, the specification unit 13 may search a plurality of operations specified for each operation in time series, and extract an operation that cannot be matched with the configuration of the robot 20.

For example, when the robot 20 has only one arm, the specification unit 13 may specify, by AI, an operation in which a human applies a force to the target object simultaneously using the left and right arms among the respective operations in the time series recognized by the recognition unit 12. Thus, it is possible to identify an operation that cannot be matched with the configuration of the robot 20.

Subsequently, the specification unit 13 of the information processing device 10 specifies an operation that can be executed by the robot 20 corresponding to the specified inconsistent operation (step S104). Thus, for example, even in a case where a series of operations in a new task in which a human indicates an exemplar includes an operation that does not match the configuration of the robot 20, the new task can be executed by the robot 20.

Here, the specification unit 13 may specify a plurality of operations (methods) that can be executed by the robot 20 and that can realize an action due to the inconsistent operation. Then, the specification unit 13 may search for a plurality of operations specified for the inconsistent operation in time series, and specify the permutation of the operation that requires a shorter time and is less difficult among the permutations of the operations that can be matched with the configuration of the robot 20.

Note that the operation executable by the robot 20 may include an operation executable only by the arm of the robot 20 and an operation executable by using a tool (for example, a tool capable of fixing a target object) that can also be used by the arm of the robot 20. Further, the operation executable by the robot 20 may include, for example, an operation using a human as a tool by a voice message (for example, a message requesting fixation of a target object) output from a speaker of the robot 20.

Subsequently, the control unit 14 of the information processing device 10 causes the robots 20 to execute the respective operations including the operations specified by the specification unit 13 (step S105). Here, as illustrated in FIG. 5, the control unit 14 may cause the robot 20 to execute each operation other than the inconsistent operation among the operations in the time series recognized by the recognition unit 12 by using imitation learning or the like. Further, the control unit 14 may cause the robot 20 to execute the operation specified by the specification unit 13 with respect to the inconsistent operation among the operations in the time series recognized by the recognition unit 12.

In the example of FIG. 5, in a task, an operation 511, an operation 512, and an operation 513 are executed in chronological order in a series of operations 510 in an action trajectory of an expert. Then, the operation 512, which is the inconsistent operation, is converted into the operation 521, which is the operation executable by the robot 20, and the operation 522 by the specification unit 13. Therefore, as a series of operations 520 executable by the robot 20, the operations 511, 521, 522, and 513 are executed by the robot in chronological order.

Hereinafter, an example will be described in which, in a case where the robot 20 has only one arm, the inconsistent operation is converted into an operation executable by the robot 20. The following examples may be combined as appropriate. Example of Applying Force After Fixing the Object

When the action trajectory of the expert includes an operation of applying a force to another part of the target object with the other arm while fixing a part of the target object with one arm (hand), the specification unit 13 may specify the operation as a mismatch operation in the process of the step S103. In the process of the step S104, the specification unit 13 may fix the target object using a specific tool as an operation executable by the robot 20 corresponding to the inconsistent operation, and then specify an operation of applying a force to the other part.

In this case, for example, in a task of taking out an object from a bottle, when the action trajectory of the expert includes an operation of opening the lid of the bottle with the other arm while gripping the bottle with one arm, the operation may be identified as a misalignment operation. Then, as an operation executable by the robot 20 corresponding to the misalignment operation, an operation of fixing the bottle using a specific tool and then opening the lid of the bottle may be specified.

### Example of Taking Out Objects After Fixing Doors, Etc.

When the action trajectory of the expert includes an operation of taking out the other object with the other arm while fixing the one object with one arm, the specification unit 13 may specify the operation as the inconsistent operation in the process of the step S103. Then, in the process of the step S104, the specification unit 13 may specify an operation of taking out the other object after fixing the one object with a specific tool as an operation executable by the robot 20 corresponding to the inconsistent operation.

In this case, for example, in a case where the action trajectory of the expert in the task of taking out the object from the refrigerator includes an operation of taking out the object in the refrigerator by the other arm while fixing the door of the refrigerator in the open state by one arm, the operation may be specified as a mismatch operation. Then, as an operation executable by the robot 20 corresponding to the inconsistent operation, an operation of fixing the door of the refrigerator using a specific tool and then taking out an object in the refrigerator may be specified.

### Example of Closing Doors, Etc., After Placing Objects

When the action trajectory of the expert includes an operation of applying a force to the other object by the other arm while holding the one object by one arm, the specification unit 13 may specify the operation as a mismatch operation in the process of the step S103. Then, in the process of the step S104, the specification unit 13 may specify an operation of placing the one object on the floor or the like and then applying a force to the other object as an operation executable by the robot 20 corresponding to the misalignment operation.

In this case, for example, in a case where the action trajectory of the expert in the task of taking out the object from the refrigerator includes an operation of closing the door of the refrigerator while holding the object by one arm, the operation may be specified as a mismatch operation. As an operation executable by the robot 20 corresponding to the inconsistent operation, an operation of placing an object taken out from the refrigerator on a floor or the like and then closing a door of the refrigerator may be specified. Example of Closing by Pushing the Door, etc. With an Object Being Gripped

When the action trajectory of the expert includes an operation of applying a force to the other object by the other arm while holding the one object by one arm, the specification unit 13 may specify the operation as a mismatch operation in the process of the step S103. Then, in the process of the step S104, the specification unit 13 may specify, as an operation executable by the robot 20 corresponding to the misalignment operation, an operation of applying a force to the other object by the object being gripped while gripping the one object.

In this case, for example, in a case where the action trajectory of the expert in the task of taking out the object from the refrigerator includes an operation of closing the door of the refrigerator while holding the object by one arm, the operation may be specified as a mismatch operation. As an operation executable by the robot 20 corresponding to the mismatching operation, an operation of pressing and closing the door of the refrigerator with the object being gripped while gripping the object taken out from the refrigerator may be specified.

### Modification

The information processing device 10 may be a device included in one housing, but the information processing device 10 of the present disclosure is not limited to this. Each unit of the information processing device 10 may be realized by, for example, cloud computing constituted by one or more computers. Such an information processing device is also included in an example of the “information processing device” of the present disclosure.

Note that the present disclosure is not limited to the above embodiment, and can be appropriately modified without departing from the spirit.

What is claimed is:

1. An information processing device comprising:
an acquisition unit configured to acquire information indicating an action trajectory of an expert for a specific task;
a recognition unit configured to recognize each operation for a target object in time series based on the action trajectory; and
a specification unit configured to specify each operation of causing a robot to execute the task based on the each operation recognized by the recognition unit and a configuration of the robot.

2. The information processing device according to claim 1, wherein:
the action trajectory includes an operation of, while fixing one part of the target object by one arm, applying a force to the other part of the target object by the other arm; and
the specification unit is configured to specify an operation of causing one arm of the robot to execute an operation of applying a force to the other part after fixing the target object using a specific tool.

3. The information processing device according to claim 1, wherein:
the target object includes a plurality of objects;
the action trajectory includes an operation of, while fixing one object by one arm, taking out the other object by the other arm; and
the specification unit is configured to specify an operation of causing one arm of the robot to execute an operation of taking out the other object after fixing the one object with a specific tool.

4. The information processing device according to claim 1, wherein:
the target object includes a plurality of objects;
the action trajectory includes an operation of, while holding one object by one arm, applying a force to the other object by the other arm; and
the specification unit is configured to specify an operation of causing one arm of the robot to execute an operation of applying a force to the other object after placing the one object.

5. The information processing device according to claim 1, wherein:
the target object includes a plurality of objects;
the action trajectory includes an operation of, while holding one object by one arm, applying a force to the other object by the other arm; and
the specification unit is configured to specify an operation of causing one arm of the robot to execute an operation of applying a force to the other object while holding the one object.

6. An information processing method comprising:
acquiring information indicating an action trajectory of an expert for a specific task;
recognizing each operation for a target object in time series based on the action trajectory; and
specifying each operation of causing a robot to execute the task based on the recognized each operation and a configuration of the robot.

7. A non-transitory storage medium storing instructions that are executable by one or more processors and that cause the one or more processors to execute functions comprising:
acquiring information indicating an action trajectory of an expert for a specific task;
recognizing each operation for a target object in time series based on the action trajectory; and
specifying each operation of causing a robot to execute the task based on the recognized each operation and a configuration of the robot.
